(19) United States
(12) Patent Application Publication
(10) Pub. No.: US 2015/0282501 A1
(43) Pub. Date: Oct. 8, 2015

(54) Topping Dispenser

(71) Applicant: E. Mishan & Sons, Inc., New York, NY (US)

(72) Inventor: Steven Mishan, New York, NY (US)

(73) Assignee: E. MISHAN & SONS, INC., New York, NY (US)

(21) Appl. No.: 14/245,305

(22) Filed: Apr. 4, 2014

(51) Int. Cl. A23G 9/24; B65D 83/04; B65D 83/06

(52) U.S. Cl. CPC A23G 9/245; B65D 83/06; B65D 83/04; B65D 2583/0481

(57) ABSTRACT

A topping dispenser has a housing with a supporting base forming its floor. The supporting base has a base evacuation hole formed in it. There is a sliding gate installed within the base. The sliding gate is biased away from a first end of the base by a spring. The sliding gate also has an evacuation hole formed in it. There is also an agitating finger fixed on the sliding gate which moves through the toppings held in the housing. When the spring is resisted, the sliding gate evacuation hole and base evacuation hole move into alignment as the agitating finger moves through the topping particles separating any adhered or caked particles which are thereby separated and more easily pass through the aligned base evacuation hole and gate evacuation hole.

### FIELD AND BACKGROUND OF THE INVENTION

The present invention relates generally to dispensing devices for food products, and more particularly to a self-serve dispenser for serving portions of dry toppings and the like from a container. The invention is useful for applying toppings to smoothies, frozen yogurt, ice cream, and the like.

A variety of dispensers are known in the art for delivering toppings. Such dispensers are able to contain and dispense a wide variety of toppings, including chocolate chips, mini marshmallows, hard candies, peanut butter chips, crushed cookies, cereal crumbles, cookie dough, candy lemon slices, crushed preztels, cranbarries, peanuts, cashews, sunflower seeds, pecans, peppermints, crushed up cone pieces, twizzler pieces, sprinkles (“jimmies”), cherries, strawberries, coconut shreds, brown sugar, powdered sugar, gummy bears, chocolate chunks, jelly beans, walnuts, swedish fish, nonpariels, blueberries, candy corns, gummy fruits.

Many of the above toppings, due to their sweet coating (e.g., hard candy) and/or conduciveness to being pressed (gummy bears, marshmallows, crushed cookies), adhere to one another. This creates a highly undesirable situation. Among other things, it results in caking and such caking may result in “cake” sizes which exceed the dimensions of the evacuation hole through which the topping is to be dispensed. In such case, the topping will not be dispensed, or, in order to uncake the toppings, the cover will have to be removed and the toppings agitated. Or the entire dispenser will need to be shaken or struck against a hard surface, which can result in damage to the dispenser.

A drawback to conventional topping dispensers, both manual and electric, is that they do not provide a solution by which caked or clumped toppings may be broken up so that they are delivered smoothly and efficiently. This leads to waste and user frustration.

The present topping dispenser seeks to address these and other related issues not addressed or solved by the prior art.

### SUMMARY OF THE INVENTION

Accordingly, it is an object of the present invention to provide an improved topping dispenser.

In one aspect of the invention, a dispenser for dispensing food items, namely toppings for smoothies, frozen yogurt, ice cream and the like is provided which includes a housing defining at least one cavity which contains the toppings. The housing has a supporting base forming its floor. The supporting base has a first end and a second end and a base evacuation hole formed in it.

There is a sliding gate—which, in typical embodiments, is a plunger with a thumb-receiving part and a plunger arm—slidably installed within the base. The sliding gate has a spring fixed at its first end. The sliding gate protrudes from an opening in the supporting base. The sliding gate is biased away from the first end of the base by the spring. The sliding gate also has an evacuation hole formed in it. This evacuation hole is approximately equal in circumference with the evacuation hole in the base.

There is also an agitating finger fixed on the sliding gate substantially perpendicular to the horizontal axis of the sliding gate. The agitating finger is positioned between the gate evacuation hole and the first end of the sliding gate.

There is also a lid over the housing, the lid is pivotally fixed to the top of the housing. The lid may be opened to deliver toppings into the cavity of the housing.

The spring is of such a length and stiffness that, when unresisted, positions the gate in a closed position. When it is in this position, the base evacuation hole is blocked and the dispensible items are prevented from exiting the housing through the base evacuation hole. When the spring is fully resisted by pressure applied against the thumb-receiving part of the plunger, the gate evacuation hole is aligned with the base evacuation hole. In this way, dispensible items may exit the dispenser.

When the spring is resisted by pressing against the pressure-receiving part, the agitating finger moves through the toppings held in the cavity, whereby at least some dispensible items which are adhered are separated and more easily pass through the aligned base evacuation hole and gate evacuation hole.

The housing may be one piece with the supporting base. The housing may also be a separate piece from the supporting base.

The housing can be divided into multiple compartments, so that different types of toppings may be accommodated in a single topping dispenser. In these embodiments, each compartment has its own agitating finger.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

It will be understood that the present invention includes any combination of these the various features of novelty which characterize the invention and any combination of equivalent features. The embodiments which follow are presented for the purposes of illustration only and are not meant to limit the scope of the present invention. Thus, all the features of the embodiments which follow are interchangeable so that each of element each embodiment may be applied to all of the embodiments taught herein.

### BRIEF DESCRIPTION OF THE DRAWINGS

In the drawings:

FIG. 1 is a side elevational view of the topping dispenser, attached to a smoothie maker;

FIG. 2 is a side, top perspective view of the topping dispenser, attached to a smoothie maker;

FIG. 3A is a top plan view of the topping dispenser, attached to a smoothie maker, in which all evacuation holes are closed;

FIG. 3B is a top plan view of the topping dispenser, close-up relative to the view of FIG. 3A, in which one of the evacuation holes is open;

FIG. 4 is a front elevational view of the topping dispenser, attached to a smoothie maker;

FIG. 5 is a top, front perspective view of the topping dispenser, attached to a smoothie maker;

FIG. 6 is a bottom plan view of the topping dispenser, detached from the smoothie maker;

FIG. 7 is a rear elevational view of the topping dispenser, detached from the smoothie maker;

FIG. 8 is a top plan view of the supporting base, with the top of the supporting base removed, to show the operation and components of the sliding gate feature;

FIG. 9 is a rear perspective view of the supporting base, with the top of the supporting base removed, to show another view of the operation and components of the sliding gate feature; and

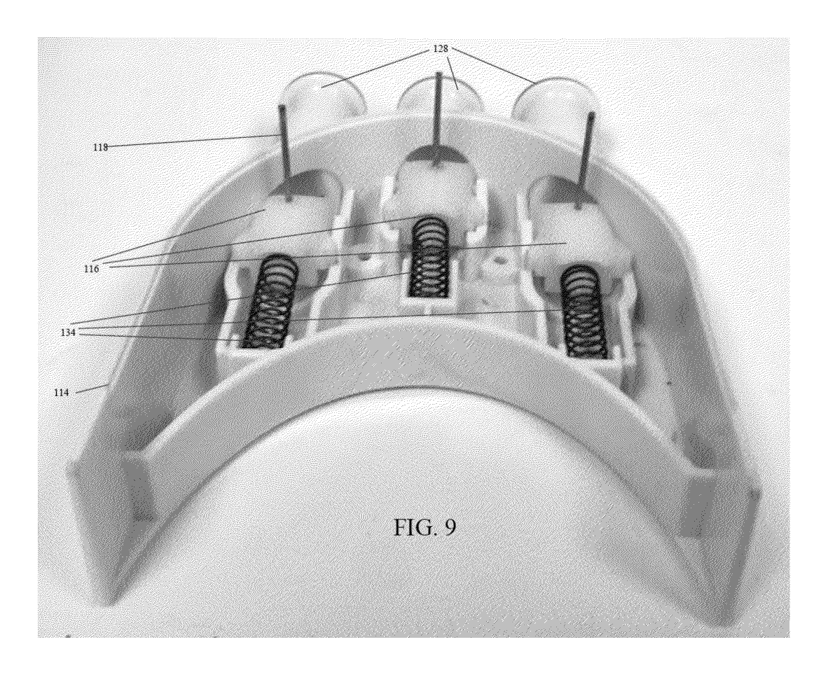

FIG. 10 depicts an embodiment of the invention in which the agitating finger is provided in a housing with a motor and a power source.

### DESCRIPTION OF THE PREFERRED EMBODIMENTS

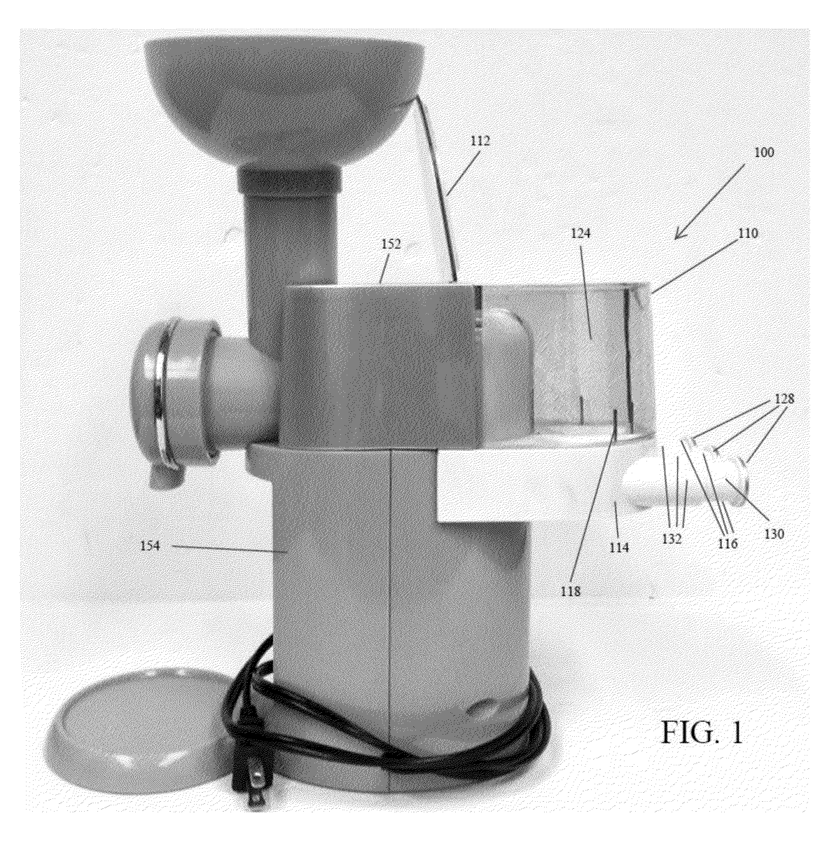

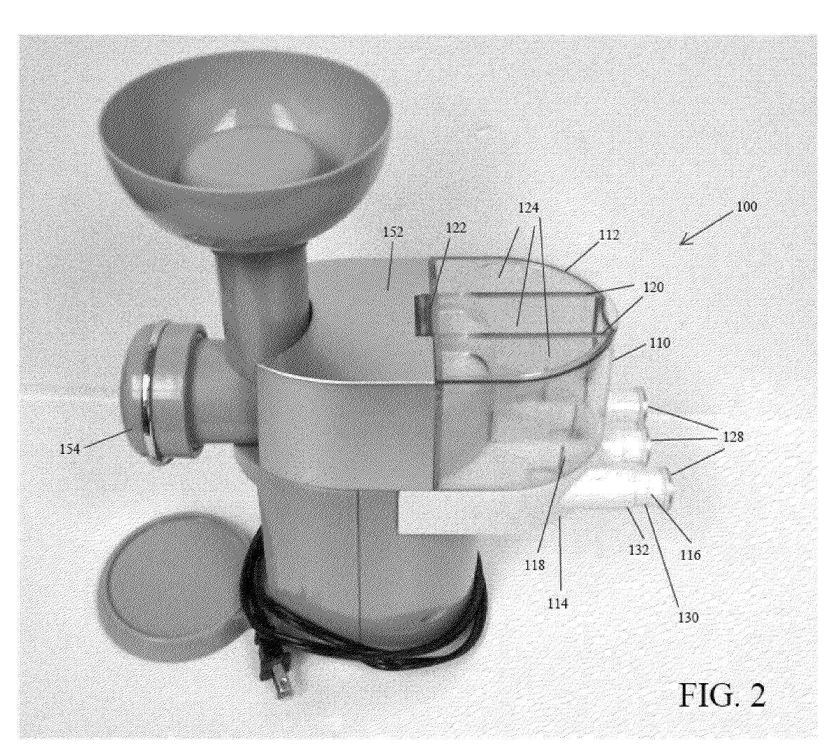

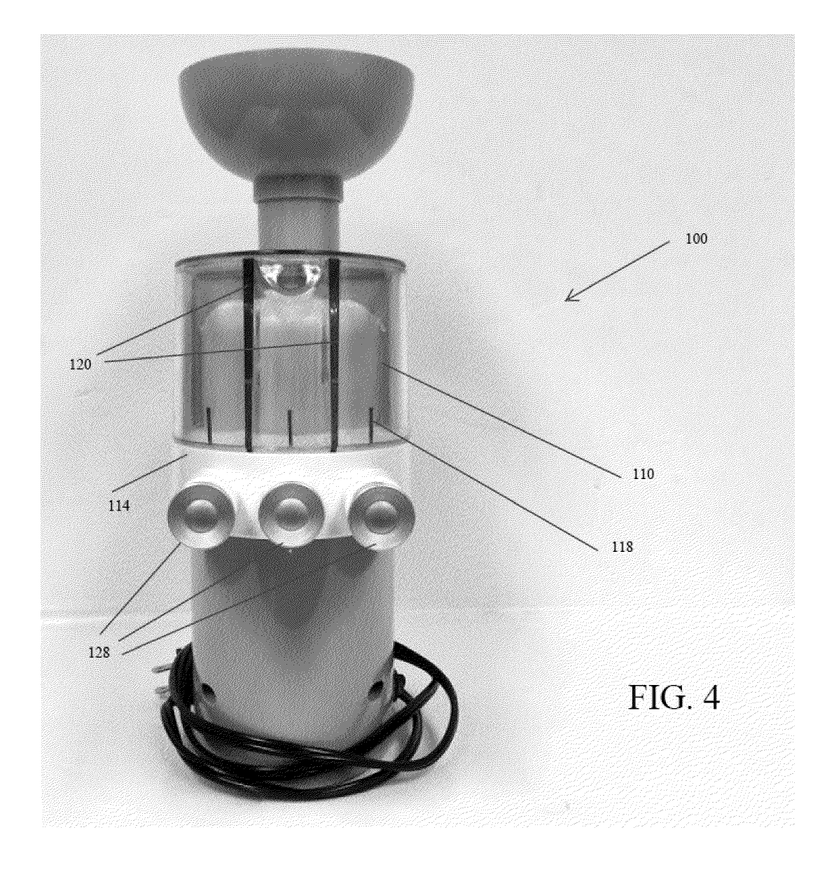

Referring now to the drawings, FIGS. 1-5 show a preferred embodiment of the topping dispenser system 100 according to the present invention. This depicted preferred embodiment includes a housing 110 defining a cavity or a group of cavities 124, each of which is able to contain a broad range of dry toppings. The housing 110 has an associated supporting base 114 forming its floor. In certain embodiments, the housing 110 is one piece with the supporting base 114. The housing 110 may also be a separate piece from the supporting base 114.

The housing 110 can be divided into multiple compartments by dividers 120, so that different types of toppings may be accommodated in a single topping dispenser 100. In these embodiments, each compartment has its own agitating finger 118.

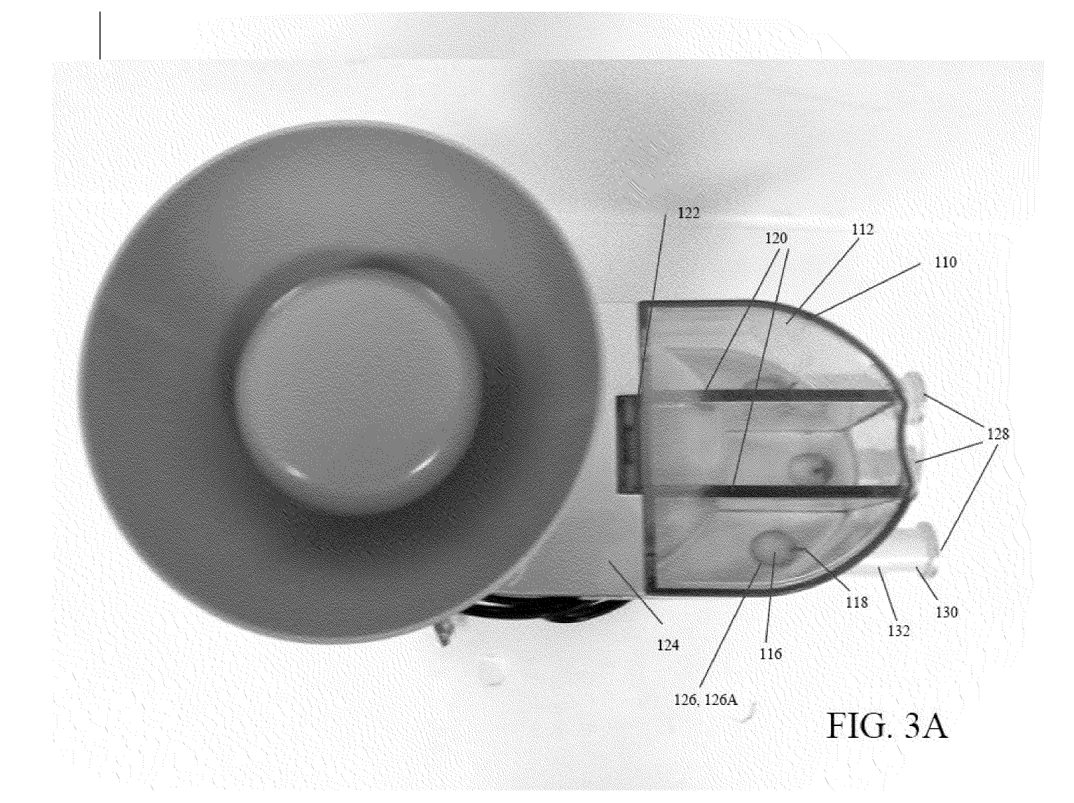

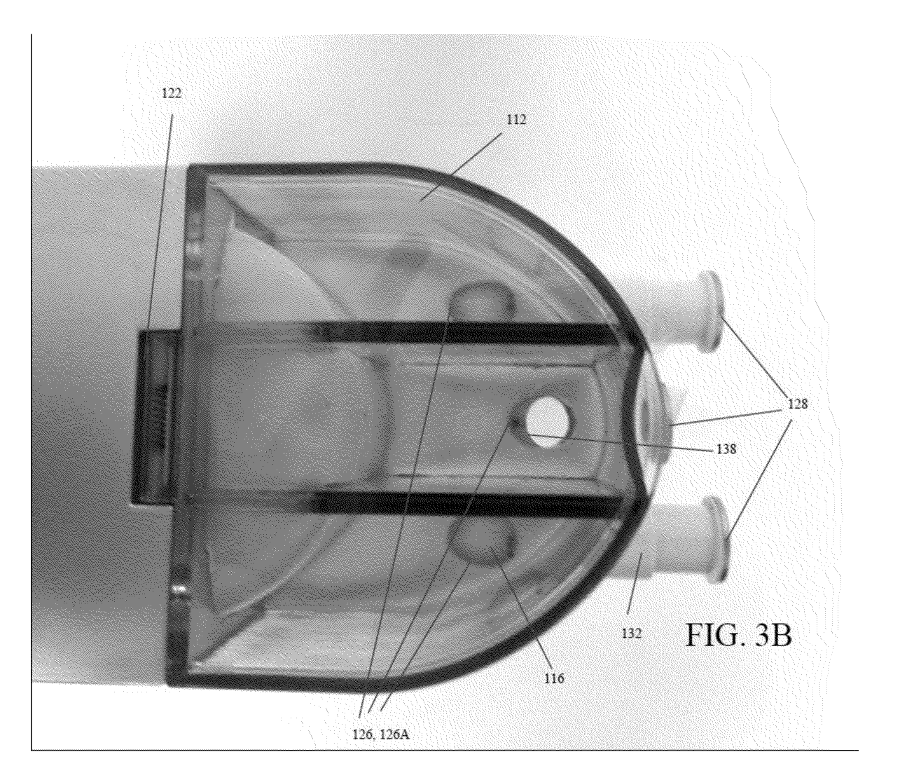

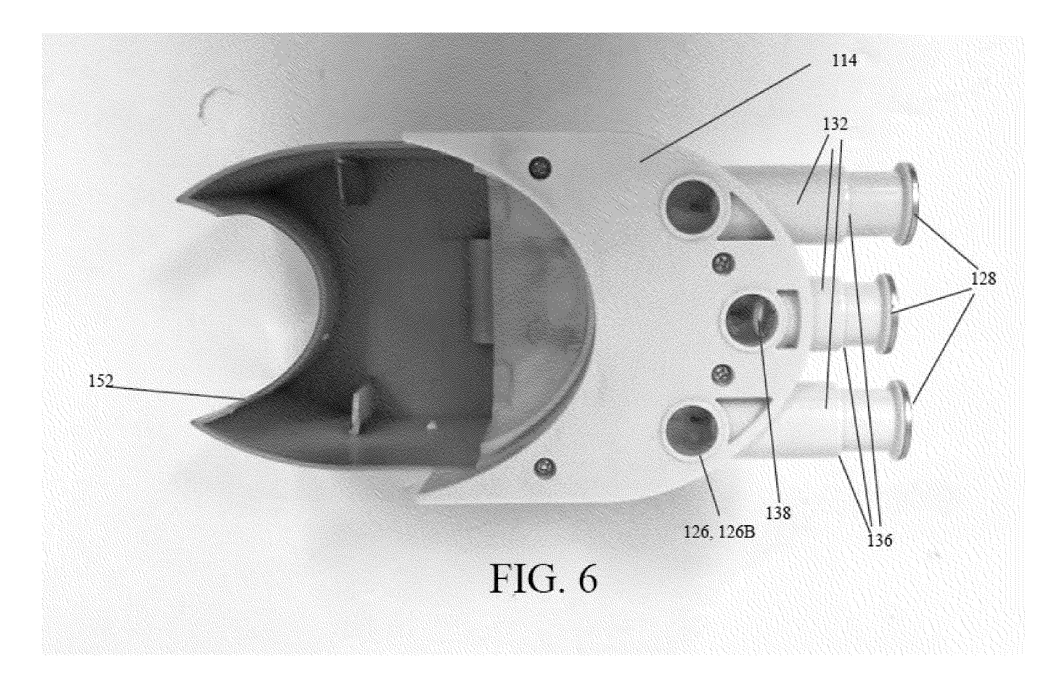

As can be best seen in FIGS. 3A and 3B, the supporting base 114 defines a base evacuation hole 126 formed therein, with a top part 126A visible in FIGS. 3A and 3B, and a bottom part 126B, shown in FIG. 6.

There is also a lid 112 over the housing 110, the lid 112 is pivotally fixed to the top of the housing by a hinge 122. The lid 112 may be opened to deliver dry toppings into the cavity of the housing 110.

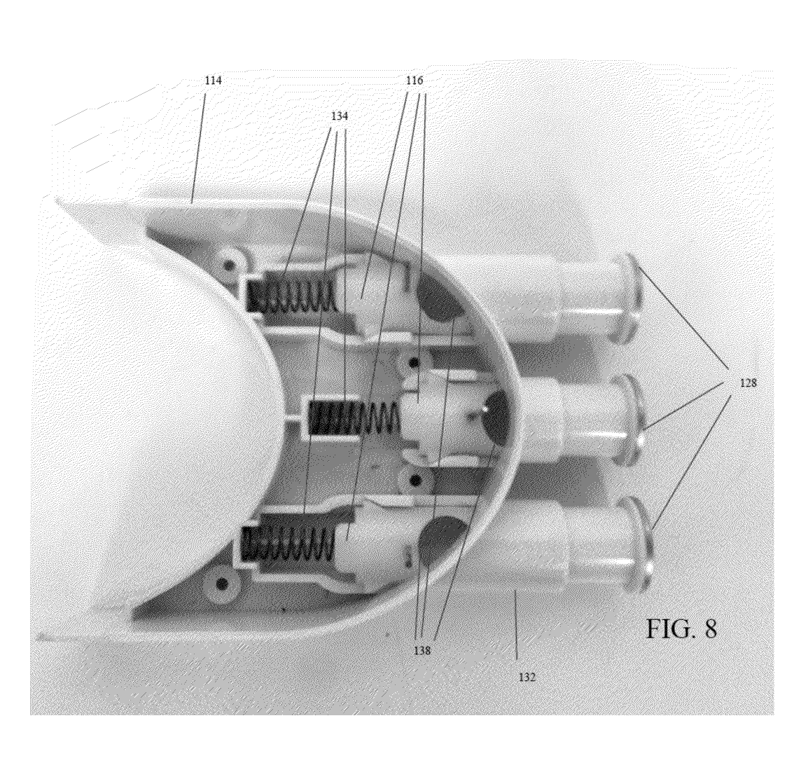

As best seen in FIG. 8, the base 114 defines at least one channel 132. A sliding gate 116 is installed within the channel 132, and slides back and forth within the channel 132. As best seen in FIGS. 1, 2, 5, 6 and 8, the sliding gate 116 is smaller in circumference than the channel 132, so that it is able to slide back and forth within the channel 132. But it is only slightly smaller in circumference, so that it is secured within the channel 132 without wobbling. The sliding gate 116 is, in typical embodiments, a plunger with a pressure-receiving portion 128 and a plunger arm 130. It is within the scope of the invention for the pressure receiving portion 128 to be adapted to conveniently receive a finger or thumb or any other part of the hand.

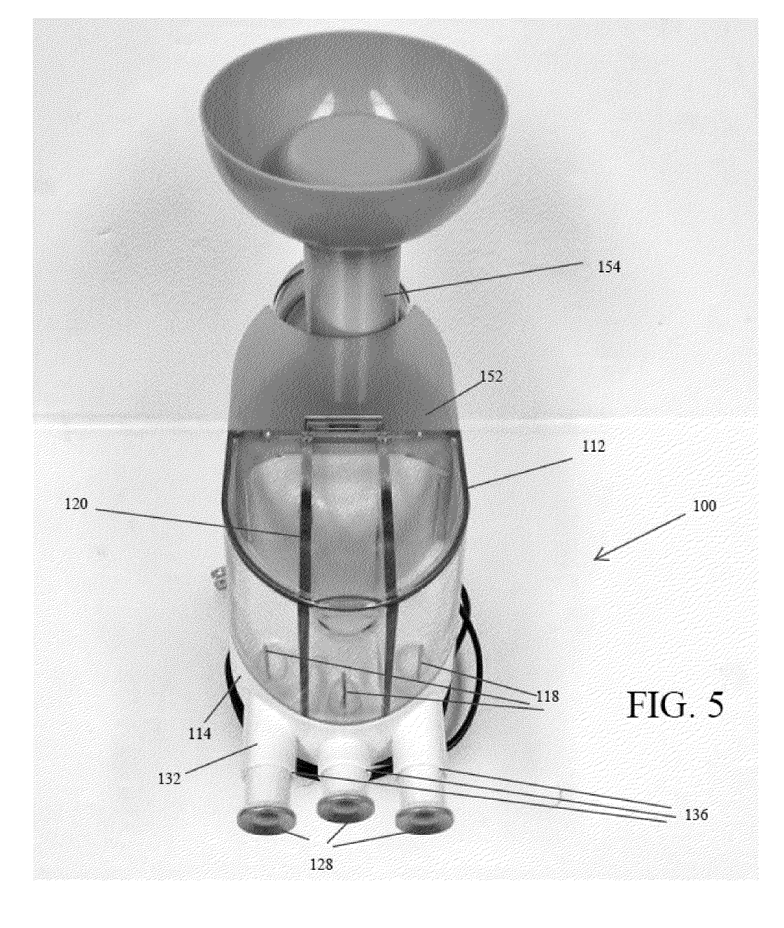

As best seen in FIGS. 5 and 6, the sliding gate 116 protrudes from an opening 136 in the channel 132 of the supporting base 114. Returning to FIG. 8, the sliding gate has a spring 134 positioned on one end. The sliding gate 116 is biased away from the first end of the base by the spring 134. The sliding gate 116 also defines an evacuation hole 138 therein. This evacuation hole 138 is approximately equal in circumference with the bottom part 126B of the evacuation hole 126 of the supporting base 114.

The spring 134 is of such a length and stiffness that, when unresisted, positions the sliding gate 116 in a closed position. When it is in this position, both parts of the base evacuation hole 126 are blocked and the dispensible items are prevented from exiting the housing 110 through the base evacuation hole 126. When the spring 134 is compressed by pressure applied against the thumb actuated pressure-receiving part 128 of the sliding gate 116, the gate evacuation hole 138 is aligned with the base evacuation hole 126, so that the toppings may exit the dispenser 100.

The spring 134 may be made from a flexible and elastic plastic. If made from such a plastic, the spring 134 can be formed integrally with the sliding gate 116 or the supporting base or both. Alternatively, the spring 134 can be made from metal, or any other material which will flex or spring between a relaxed state and a compressed state.

As best seen in FIGS. 1, 2, 4 and 5, there is also an agitating finger 118 fixed on the sliding gate 116 substantially perpendicular to the horizontal axis of the sliding gate 116 and extending into the cavity 124 above that gate. The agitating finger 118 is positioned between the gate evacuation hole 138 and the first end of the sliding gate 116. In operation, when a user presses against the pressure-receiving part 128, the agitating finger 118 moves through the dry toppings contained in the housing 110, breaking up adherances and reducing caking. In this way, adhered or caked topping particles are separated and more easily pass through the opening created by the aligned holes 126, 138. To allow such movement, the upper part 126A of the evacuation hole 126 is elongated into an oval shape to allow the finger 118 to move to the rear of the hole part 126A when the gate 116 is at the end of its stroke in channel 132.

The agitating finger 118 may be made of any type of metal, including, but not limited to stainless steal. The agitating finger 118 may, alternatively, be made of plastic. If made from plastic, the agitating finger 118 can be formed integrally with the sliding gate 116.

While the agitating finger 118 is shown for simplicity as a simple vertical bar in FIGS. 1, 2, 4 and 5, it is within the scope of the invention for the agitating finger 118 to be of any convenient and efficacious shape for effecting agitation of toppings within the housing 110. Thus, the agitating finger 118 may be, for example a flat paddle-like structure having an effective width. The agitating finger 118 may, as well, have one or more teeth, the teeth being sufficiently spaced so that toppings particles would not be caught therebetween. It is also within the scope of the invention for a variety of accessory agitators (e.g., toothed or flat paddles) to be provided with the dispenser system 100, which may be easily slid onto and removed from the agitating finger 118. Thus, the agitating finger 118 may be modified in accordance with the particular type of topping being provided in the cavity 124 at the time.

It is also within the scope of the invention for the agitation finger 118 to have a vibrating function for improving breakup of toppings particles.

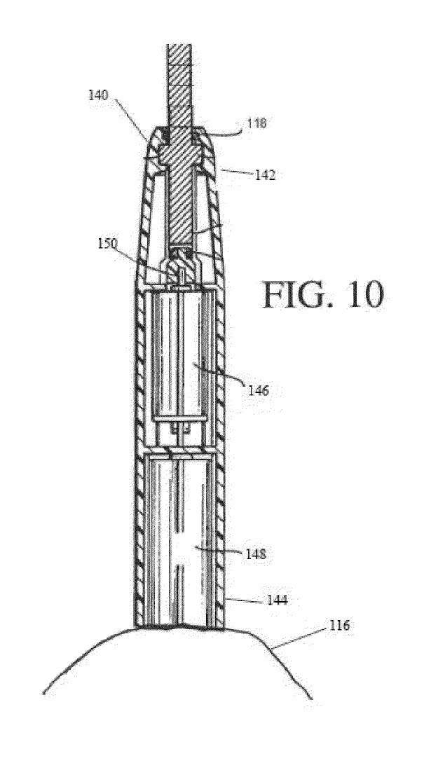

As shown in FIG. 10, in these embodiments, a small housing 140, from which the agitating finger 118 protrudes, is provided on the sliding gate 116. The, housing 140 has a proximal end 142, a distal end 144, the agitating finger protruding from the proximal end 142.

Also disposed within the housing 140 is an electrical motor 146 and a power source 148, which may be, for example, a 1.5 volt AAA battery. The power source 148 is in electrical communication with the motor 146. Power source 148 may be rechargeable either in an external recharger or within housing 140 by providing suitable electrical contacts (not shown) through the housing 140. It will be appreciated by those skilled in the art that a suitable switch (not shown) may be provided at any convenient location on the dispenser 100 to control the actuation of the electric motor 146.

Electric motor 148 has a shaft 150 which vibrates upon the actuation of the electrical motor 148. While the speed of vibration can vary within wide limits without departing from the scope of the present invention, the vibration function is contemplated to be within a range such that it is sufficient for breaking up the toppings particles, but not so strong as to disturb the overall stability of the dispenser 100.

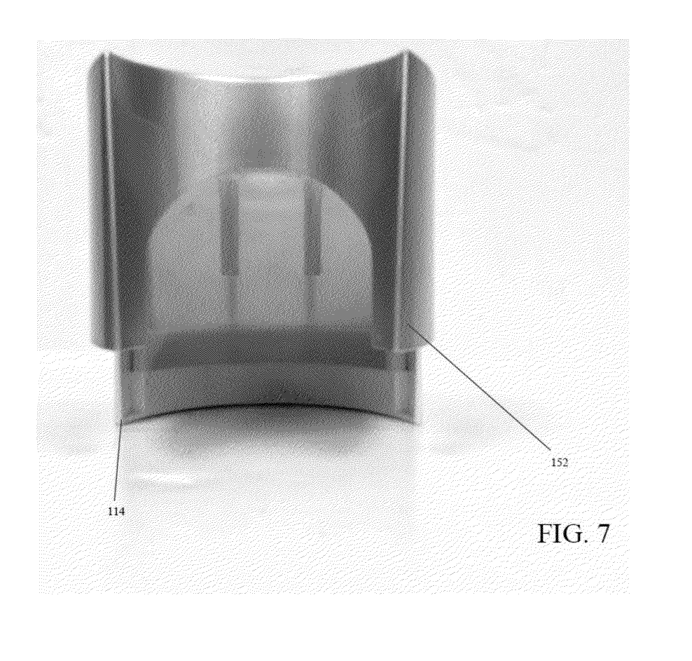

As best seen in FIGS. 1, 2, 5, and 7, the toppings dispenser 100 is provided with a backing 152 adapted for easily securing the topping dispenser 100 to a smoothie maker 154 or the like. While the backing 152 shown in FIGS. 1, 2, 5, and 7 is a concave backing, the backing may be in any shape or orientation for conveniently securing the dispenser to a smoothie maker 154. The backing 152 may be one piece with the topping dispenser 100, forming a back wall thereof or may be separate piece. It is also within the scope of the invention for the backing 152 to be secured to a smoothie maker 154 or the like by any convenient securing device. Such device may be a mechanical securing device such as a clip (not shown). It may also be a magnetic securing device, such as a pair of oppositely poled-magnets. In certain embodiments, the alternative securing device may be the primary device for securing the dispenser 100. In other embodiments, it may be a secondary device, with the concave or other shape, for example, being the primary device.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

It will be understood that the present invention includes any combination of these the various features of novelty which characterize the invention and any combination of equivalent features. The embodiments which follow are presented for the purposes of illustration only and are not meant to limit the scope of the present invention. Thus, all the features of the embodiments which follow are interchangeable so that each of element each embodiment may be applied to all of the embodiments taught herein.

While a specific embodiment of the invention has been shown and described in detail to illustrate the application of the principles of the invention, it will be understood that the invention may be embodied otherwise without departing from such principles. It will also be understood that the present invention includes any combination of the features and elements disclosed herein and any combination of equivalent features. The exemplary embodiments shown herein are presented for the purposes of illustration only and are not meant to limit the scope of the invention. Thus, all the features of all the embodiments disclosed herein are interchangeable so that any element of any embodiment may be applied to any of the embodiments taught herein.

What is claimed is:

1. A dispenser for delivering a plurality of dispensable items, comprising:
a housing defining at least one cavity adapted to contain the plurality of dispensable items;
a supporting base forming a floor of said housing, said supporting base having first end and a second end, and defining a base evacuation hole formed therein, said base evacuation hole having an upper part and a lower part;
a sliding gate slidably installed within said base, said sliding gate having a first end and a second end, and a spring fixed at said first end of said sliding gate, said second end of said sliding gate protruding from an opening in said supporting base, said sliding gate being biased away from said first end of said base by said spring, said sliding gate defining a gate evacuation hole formed therein, said gate evacuation hole being approximately equal in circumference with said base evacuation hole;
an agitating finger fixed on said sliding gate substantially perpendicular to a horizontal axis of said sliding gate, said agitating finger being positioned between said gate evacuation hole and said first end of said sliding gate;
a lid over said housing, said lid being pivotally fixed to a top of said housing, such that said lid may be opened to deliver dispensible items to said cavity of said housing;
wherein said spring is of such a length and stiffness that, when unresisted, positions said sliding gate in a closed position, such that said base evacuation hole is blocked and said dispensible items are prevented from exiting said housing through said base evacuation hole, and when said spring is fully resisted by pressure applied against the second end of said sliding gate, said gate evacuation hole is aligned with said base evacuation hole, whereby said dispensible items may exit the dispenser; and
wherein said agitating finger moves through said plurality of dispensible items when said spring is resisted, whereby at least some dispensible items which are adhered are separated and more easily pass through said aligned base evacuation hole and said base evacuation hole.

2. The dispenser of claim 1, wherein said housing is one piece with said supporting base.

3. The dispenser of claim 1, wherein said housing is a separate piece from said supporting base.

4. The dispenser of claim 1, wherein said housing is divided into a plurality of compartments by at least one divider.

5. The dispenser of claim 4, wherein each of said compartments has its own sliding gate and agitating finger.

6. The dispenser of claim 1, wherein said sliding gate is a plunger.

7. The dispenser of claim 1, wherein said sliding gate further comprises a pressure-receiving part located at said second end of said sliding gate.

8. The dispenser of claim 1, wherein said agitating finger is made of metal.

9. The dispenser of claim 1, wherein said agitating finger is made of plastic.

10. The dispenser of claim 9, wherein said agitating finger is formed integrally with the sliding gate.

11. The dispenser of claim 1, wherein said spring is made of metal.

12. The dispenser of claim 1, wherein said spring is made of plastic.

13. The dispenser of claim 12, wherein said spring is formed integrally with said sliding gate.

14. The dispenser of claim 13, wherein said spring is formed integrally with said supporting base.

15. The dispenser of claim 1, wherein said agitating finger is a vertical bar.

16. The dispenser of claim 1, wherein said agitating finger is a flat paddle-like structure.

17. The dispenser of claim 1, wherein said agitating finger is provided with teeth.

18. The dispenser of claim 1, wherein said agitating finger is provided within an agitator housing, said housing further comprising a motor and a power source, said motor adapted to vibrate said agitating finger.

19. The dispenser of claim 1, further comprising a backing adapted to secure said dispenser to another device.

20. The dispenser of claim 18, wherein such backing is a concave backing.
